(19) United States
(12) Patent Application Publication
(10) Pub. No.: US 2008/0059544 A1
(43) Pub. Date: Mar. 6, 2008

(54) System and method for providing secure third party website histories

(76) Inventor: Rick Rahim, Great Falls, VA (US)

Correspondence Address: MCKENNA LONG & ALDRIDGE LLP, 1900 K STREET, NW, WASHINGTON, DC, 20006, US

(21) Appl. No.: 11/808,514

(22) Filed: Jun. 11, 2007

Related U.S. Application Data
(60) Provisional application No. 60/812,716, filed on Jun. 9, 2006.

(51) Int. Cl. G06F 17/30

(52) U.S. Cl. 707/204; 707/E17.005

(57) ABSTRACT

Disclosed is a system and method for archiving websites, with which a customer may designate a target domain that is to be scanned and archived. At times or frequencies designated by the customer, the system scans every web page and link associated with the target domain. The system securely archives all the information corresponding to each web page, including text, graphics, HTML source code, etc. The system subsequently re-scans the websites to identify any changes, additions, and deletions to any of the web pages associated with the target domain. The system then alerts the customer of any changes and provide information pertaining to the changes. This may allow a business entity to closely monitor website activity of a competitor, and/or allow a business entity to archive its own website in a secure manner.

This application claims the benefit of U.S. Provisional Patent Application No. 60/812,716, filed on Jun. 9, 2006, which is hereby incorporated by reference for all purposes as if fully set forth herein.

### BACKGROUND OF THE INVENTION

1. Field of the Invention

The present invention generally relates to internet archiving systems.

2. Discussion of the Related Art

The Internet (worldwide web) is a seemingly endless array of hundreds of thousand of websites, comprising hundreds of millions of individual web pages. Each website is designed and controlled by a host party, which deploys the website from a server for displaying pictures, information, or other media.

Each of these web pages may be updated based on the preferences and needs of the host party. Accordingly, the information published on the website may be updated or changed on a yearly, monthly, weekly, or daily basis, and may even occur several times a day, based upon the dynamic nature of the information presented. Given the constant updating of websites, not only does the number of websites dramatically increase, but the content of these websites always changes.

Given the dynamic nature of website content, a demand has emerged for the ability to determine the presence and content of a given host party's website at a given point in time. For example, for an internet-related business, it may be important to precisely recall the content of a sales brochure, or product specification sheet, or a price list, as was presented on a given day. This information may prove crucial in the event of litigation. In a litigation scenario, a host party may need to confirm the content of its own website, or the website of a competitor or opposing party, years after the content has changed.

Further to a litigation context, it may not be sufficient for a host party to preserve the content of its own websites, for it may be asserted that the host party may have subsequently altered the website content.

Additionally, it may be time consuming for a business entity to constantly monitor the websites of its competitors. Given the dynamic nature of website content, and depending on the complexity of a competitor's website hierarchical structure, it is likely that important changes to a competitor's website content will go unnoticed.

Accordingly, what is needed is a system for monitoring and archiving websites, which allows one to have a host party's website monitored for changes, to have each change brought to the attention of an interested party, and to have each website preserved in such a way that it is immune from subsequent alteration.

### SUMMARY OF THE INVENTION

The present invention provides a system and method for providing secure third party website histories that obviates one or more of the aforementioned problems due to the limitations of the related art.

Accordingly, one advantage of the invention is that it provides more secure and reliable website archiving.

Another advantage of the present invention is that it better enables a business entity to monitor the website activity of a competitor.

Additional advantages of the invention will be set forth in the description that follows, and in part will be apparent from the description, or may be learned by practice of the invention. The advantages of the invention will be realized and attained by the structure pointed out in the written description and claims hereof as well as the appended drawings.

To achieve these and other advantages, the present invention involves a system for archiving a website. The system comprises a processor connected to the internet; a customer terminal connected to the internet; a database connected to the processor; and a memory connected to the processor, wherein the memory is encoded with a program for obtaining a target domain from the customer terminal, obtaining a scan frequency information from the customer terminal, downloading a first web page data corresponding to the target domain at a first time corresponding to the scan frequency information, encrypting and storing the first web page data, downloading a second web page data corresponding to the target domain at a second time, computing a percentage change corresponding to the first web page data and the second web page data and reporting the percent change to the customer terminal.

In another aspect of the present invention, the aforementioned and other advantages are achieved by a method for archiving a website. The method comprises obtaining a target domain from a customer terminal; obtaining a scan frequency information from the customer terminal; downloading a first web page data corresponding to the target domain at a first time corresponding to the scan frequency information; encrypting and storing the first web page data; downloading a second web page data corresponding to the target domain at a second time; computing a percentage change corresponding to the first web page data and the second web page data; and reporting the percent change to the customer terminal.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 illustrates an exemplary system for archiving websites.

FIG. 2A illustrates an exemplary process for performing initially archiving a target domain.

FIG. 2B illustrates an exemplary sub-process for archiving a web page.

FIG. 3 illustrates an exemplary process for subsequently archiving the target domain and alerting a customer of changes.

### DETAILED DESCRIPTION OF THE ILLUSTRATED EMBODIMENTS

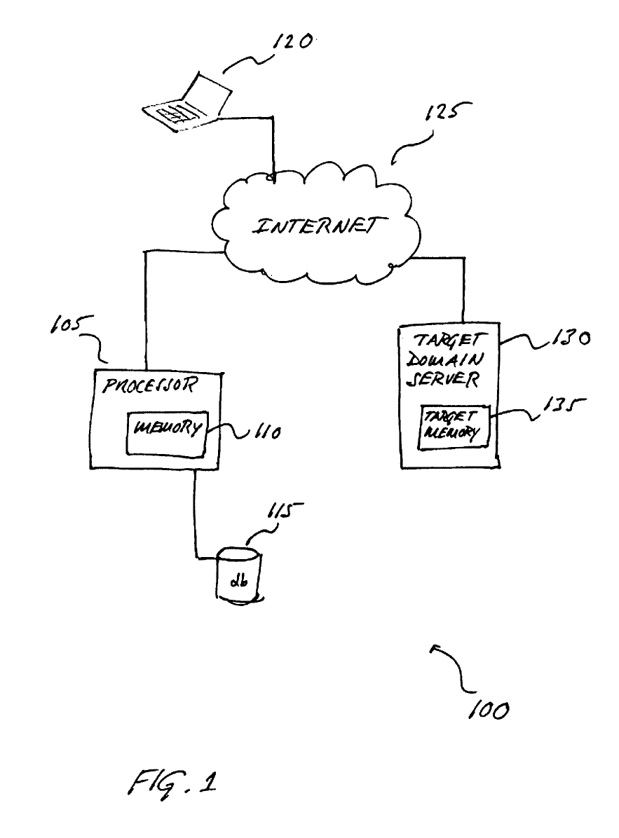

FIG. 1 illustrates an exemplary system 100. System 100 includes a processor 105, which has a memory 110. Processor 105 may be one or more computers that are co-located or in communication with each other over a network, such as the internet 125. Memory 110 may be one or more computer-readable media that contain software for implementing processes associated with the present invention. Memory 110 may include one or more memory devices that may be distributed among multiple computers making up processor 105.

Processor 105 is connected to a database 115. Database 115 may include one or more database systems, which may be co-located with processor 105 and/or distributed in one or more remote locations and connected over internet 125. One skilled in the art will readily appreciate that may such variations to processor 105, memory 110, and database 115 are possible and within the scope of the invention.

System 100 includes one or more customer terminals 120, by which a customer or subscriber may interact with processor 105. Customer terminal 120 may be a customer's laptop or desktop computer, handheld digital device, etc. Customer terminal 120 communicates with processor 105 over a network connection, which may include internet 125 and one or more wireless networks. The customer may communicate with processor 105 via a web browser running on customer terminal 120.

System 100 may be connected to a target domain server 130 over internet 125. Target domain server 130 may include one or more computers that communicate over internet 125. Target domain server 130 may have a target memory 135. Target memory 135 may be a computer readable medium encoded with instructions and data corresponding to a domain of interest. Target memory 135 may include one or more memory devices that may be distributed over many computers connected to internet 125. It will be readily apparent to one skilled in the art that many variations to target domain server 130 are possible and within the scope of the invention.

Target domain server 130 may belong to the customer, may belong to a competitor of the customer, or may belong to an entity in which the customer has an interest.

As used herein, “web page” may refer to all of the data corresponding to a URL. This may include data corresponding to text, HTML source code, graphics, files, audio, animation, and the like. “Website” may refer to any or all of the data corresponding to any or all of the web pages corresponding to a target domain, or some subset of URLs within a target domain.

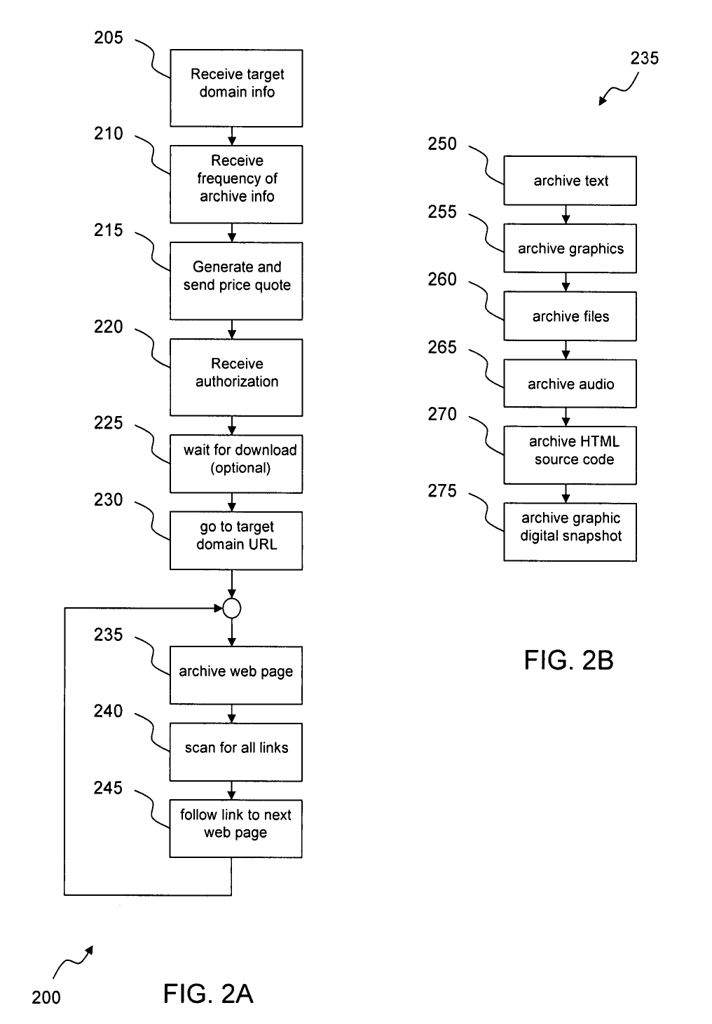

FIG. 2A illustrates an exemplary process 200 for archiving websites. The computer instructions for implementing process 200 may be stored in memory 110 and executed by processor 105.

At step 205, the customer enters target domain information into customer terminal 120, which transmits the target domain information to processor 105 via internet 125. Processor 105 receives the target domain information and may store it in memory 110.

At step 210, the customer enters information pertaining to the desired frequency of scans of the target domain (“scan frequency information”) into customer terminal 120. Customer terminal 120 transmits this information to processor 105 via internet 125. Processor 105 may store the scan frequency information in memory 110.

The scan frequency information may include information such as frequency (e.g., once per day, twice per week, and the like) along with a specified time (e.g., 8:00 am). The scan frequency information may also include specific dates and times for scanning. Specific dates and times may be entered using a calender-type web interface running on customer terminal 120.

At optional step 215, processor 105 may execute instructions to generate a price quote and transmit the price quote to customer terminal 120 over internet 125.

At step 220, the customer may issue authorization to proceed with exemplary process 200. In doing so, the customer may use customer terminal 120 to transmit authorization information to processor 105 via internet 125. Processor 105 may then receive the authorization information and store it in memory 110. The authorization information may include a username, password, credit card information, and the like.

At step 225, processor 105 may execute instructions to wait for the time specified in the scan frequency information to perform an initial scan and archive of the target domain. This step is optional. If this step is omitted, then processor 105 may execute instructions to perform an initial scan and archive of the target domain while the customer is logged onto processor 105 via customer terminal 120 and internet 125.

At step 230, processor 105 executes instructions to launch a web crawler application, or similar software component, to go to the target domain URL provided by the customer at step 205. Processor 105 may then execute instructions to download the web page data corresponding to the target domain URL.

At step 235, processor 105 executes instructions to archive the web page. As referred to herein, “web page” may refer to all data and HTML code corresponding to a given URL of interest at the initiation of step 235. If this is the first execution of step 235, then the URL corresponds to the target domain provided by the customer in step 105. Otherwise, the web page may correspond to the URL of a link found during a scan of the target domain.

FIG. 2B illustrates an exemplary sub-process for step 235, which includes steps 250-275.

At step 250, processor 105 executes instructions to archive the text within the web page. In doing so, processor 105 may execute instructions to read and store in database 115 every textual character presented on the web page. All characters may be read and stored in database 115, whether visible or not (many web pages include text information that is invisible to the user). Processor 105 may store all character presented on the web page, regardless of language. Processor 105 may execute instructions to, with every character read, increment one or more counters, the values for which are stored in database 115. Counters may include character count, word count, paragraph count, table count, bold text count, underline text count, italic text count, capitalized word count, all-caps word count, superscript character count, subscript character count, foreign language character count, spelling error count, proper name count, and the like.

At step 255, processor 105 may execute instructions to archive all graphic images, whether visible to the human eye or not. Such images may include static graphic images in formats such as .jpg, .gif, .pict, and the like. Processor 105 may also execute instructions to archive animations such as Flash, Windows Movies, Quicktime files, and the like. In doing so, processor 105 may execute instructions to store all graphic images and animations in database 115.

At step 260, processor 105 may execute instructions to archive all files presented by the web page, whether the files are visible to the human eye or not. Such files may include formats such as .txt, .wrd, .xls, .pfd, .ppt, and the like. Processor 105 may execute instructions to store these files in database 115, along with the files original file names.

At step 265, processor 105 may execute instructions to archive all audio files presented by the web page, whether they are visible to the human eye or not. Such files may include formats such as .wav, .mp3, and the like. Processor 105 may execute instructions to store these files in database 115, along with their original file names.

At step 270, processor 105 may execute instructions to archive the HTML source code corresponding to the web page. In doing so, processor 105 may execute instructions to store the HTML source code in database 115, regardless of its programming language, including any developer's comments—whether integral to the functionality of the web page or not.

At step 275, processor 105 may execute instructions to take a graphic digital snapshot of the rendered web page, and store the graphic digital snapshot in database 115. The “snapshot” may be later viewed by the customer to provide a visual depiction of what the web page looked like at the date and time of the given execution of step 235.

For the information stored in database 115 in steps 250-275, processor 105 may execute instructions to encrypt the corresponding data, along with a date/time stamp. The date/time stamp may have hundredth of a second precision, synchronized to the official World Clock in Greenwich Mean Time.

In archiving the data step 235, processor 105 may execute instructions to uniquely encrypt each web page and digitally “emboss” the encrypted data with a unique identifier to preserve data integrity. This may prevent subsequent manipulation of the archived web page data so that the archived web page may later be used as evidence in legal proceedings. One skilled in the art will readily recognize that many algorithms for encryption are known to the art and within the scope of the invention.

Returning to exemplary process 200 of FIG. 2A, at step 240, processor 105 executes instructions to scan the web page for all links, which may take a visitor to another web page when clicked. These links may include hidden links. Processor 105 may execute instructions to store all link data in database 115.

At step 245, processor 105 may execute instructions to follow the next (or first) link found in step 240. In doing so, processor 105 executes instructions to download the web page data corresponding to the URL of the link found in step 240.

Processor 105 may then return to step 235 and repeat steps 235-245. In doing so, process 200 may recursively archive all of the web pages corresponding to all of the links encountered in the target domain. At the conclusion of process 200, an initial scan of the target domain has been performed, and the web page data corresponding to the target domain has been archived in database 115.

Variations to process 200 are possible and within the scope of the invention. For example, for each link encountered at step 240, processor 105 may execute instructions to transmit the link information to customer terminal 120 along with a prompt for the customer to approve following the link. The customer, using customer terminal 120, may provide instructions to processor 105 to proceed along the link in question, or to bypass the link and proceed to the next identified link. One skilled in the art will readily appreciate that such variations to process 200, including such customer interaction, are possible and within the scope of the invention.

Having performed an initial website archive, subsequent archiving of the website may be done in the context of the initial website archive.

Depending on the scan frequency information provided by the customer in step 210, processor 105 may execute instructions to identify that it is the time for the next scan.

In performing the next scan and archive, processor 105 may execute instructions to perform a subsequent website archive that involves comparing the current archived web page data with the previously stored (or initial) archived web page data in database 115.

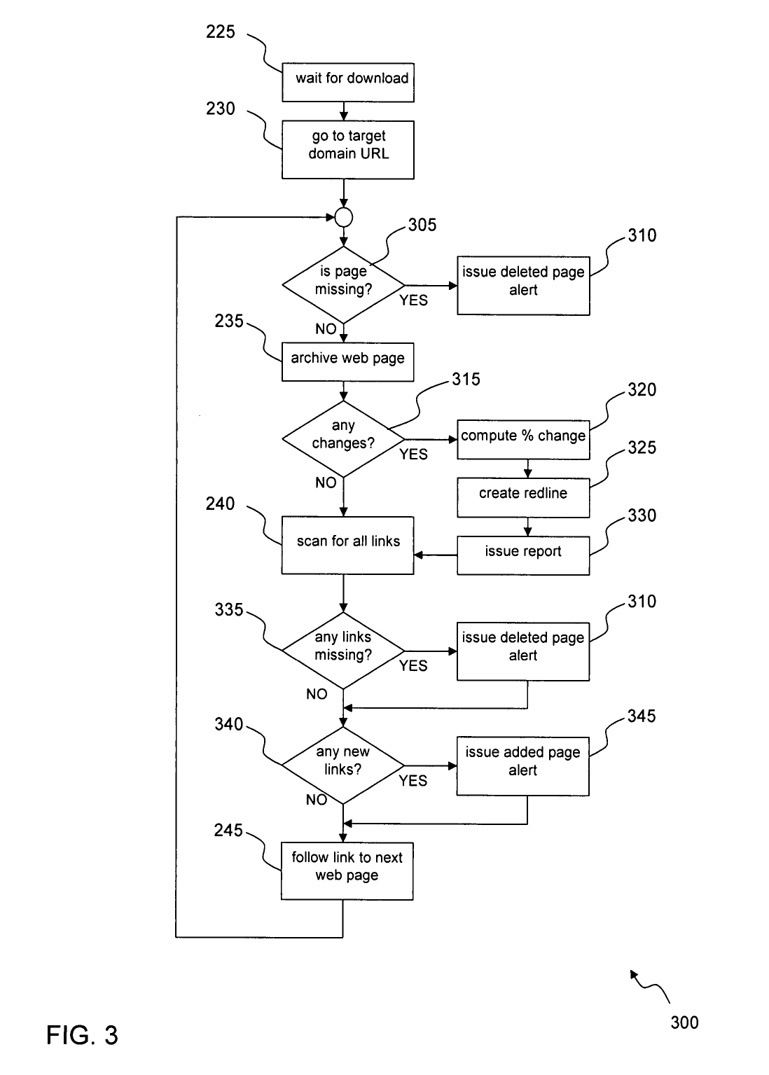

FIG. 3 illustrates an exemplary process 300 for performing a subsequent website archive. Many of the steps of exemplary process 300 may be substantially similar to corresponding steps of exemplary process 200. In this case, the same reference numbers are used.

At step 225, processor 105 executes instructions to compare the processor's current time with the scan frequency information provided by the customer at step 210 of process 200. At the appropriate time, processor 105 executes instructions to proceed with the remaining steps of exemplary process 300.

At step 230, processor 105 executes instructions to launch a web crawler application, or similar software component, to go to the target domain URL provided by the customer at step 205. Processor 105 may then download the web page data corresponding to the target domain URL.

At step 305, if no web page data is found corresponding the given URL, process 300 proceeds along the YES branch of step 305 to step 310.

At step 310, processor 105 executes instructions to issue a deleted page alert to customer terminal 120 via internet 125. The deleted page alert may be in the form of an email message, which is transmitted to customer terminal 120, although other forms of electronic messaging may be used, such as text messaging, and the like.

If the URL has corresponding web page data, process 300 proceeds along the NO branch of step 305 to step 235.

At step 235, processor 105 executes instructions to archive the web page, as described with regard to step 235 of process 200 above.

At step 315, processor 105 executes instructions to compare the archived web page data of this iteration (“newly archived web page) of step 235 with a previous iteration of step 235, as done in process 200 described above, or in a previous iteration of process 300. If there are any changes detected in the web page data, process 300 proceeds along the YES branch of step 315 to step 320.

At step 320, processor 105 executes instructions to compute a percentage change between the newly archived web page with the previously archived web page data. In doing so, processor 105 may execute instructions to compute a change in text, graphics, links, files, audio, HTML source code, and any other information archived in step 235. Processor 105 may store the percentage change data in memory 110.

At step 325, processor 105 may execute instructions to create a redline file, which illustrates the changes between the newly archived web page with the previously archived web page. The file may include a “side-by-side” comparison between the two archived web pages. The side-by-side comparison may include underlines and strikeouts to indicate added and removed information. One skilled in the art will readily recognize that various methods for depicting a side-by-side comparisons are possible and within the scope of the invention. Processor 105 may store the redline file in memory 110.

At step 330, processor 105 may execute instructions to issue a report of the percentage change and redline file to customer terminal 120. In doing so, processor 105 may execute instructions to generate a file, which may be in an html, Word, rich text format (RTF) or similar, and transmit the file to customer 120 as an attachment to an email.

At the conclusion of step 330 (or in accordance with the NO branch of step 315), process 300 proceeds to step 240. At step 240, processor 105 executes instructions to scan for all links within the web page data, as is described with respect to step 240 of process 200 above.

At step 335, processor 105 executes instructions to determine if any links in the previously archived web page are missing in the newly archived web page. If a link is missing, process 300 proceeds along the YES branch of step 335 to step 310, in which processor 105 executes instructions to issue a deleted page alert, as described above.

If there are no links missing in the newly archived web page, process 300 proceeds along the NO branch of step 335 to step 340.

At step 340, processor 105 executes instructions to determine if there are any new links in the newly archived web page compared to the previously archived web page. If so, process 300 proceeds along the YES branch of step 340 to step 345.

At step 345, processor 105 executes instructions to issue an added page alert to customer terminal 120 via internet 125. The added page alert may be in the form of an email message, which is transmitted to customer terminal 120, although other forms of electronic messaging may be used, such as text messaging, and the like. The added page alert may include a query prompting the customer whether to follow the newly detected link and archive the corresponding web page. Process 300 may proceed without an answer to the prompt (with a customer-provided default decision) or wait for an answer.

If there are no new links in the newly archived web page data, process 300 proceeds along the NO branch to step 245.

At step 245, processor 105 At step 245, processor 105 executes instructions to follow the next (or first) link found in step 240. In doing so, processor 105 executes instructions to download the web page data corresponding to the URL of the link found in step 240.

Process 300 returns to step 305, using the web page data of the new link. Process 300 may recursively archive and compare all of the web pages corresponding to all of the links encountered in the target domain. At the conclusion of process 300, a subsequent scan of the target domain has been performed, the newly archived web page data is compared to the previously archived web page data, appropriate alerts have been issued to the customer, and the newly archived web page data is stored in database 115.

Variations to exemplary process 300 are possible and within the scope of the invention. For example, the deleted page alert issued in step 310, the report issued in step 330, and the added page alert issued in step 345 may be performed once at the end of all iterations of process 300. In this case, all of the related information may be transmitted to customer terminal 120 in a single email attachment (for example). Alternatively, an email or text message may be transmitted to customer terminal 120 with a website link, which contains all of the alert and report information generated in process 300.

In another variation of process 300, the archive web page step 235 may only be performed if the web page has changed since the previous (or initial) archive. This may prevent redundant web pages from being archived in database 115. This may be particularly useful if the scan frequency information (provided in step 210) calls for frequent (e.g., daily) scans of the target domain. One skilled in the art will readily appreciate that such variations are possible and within the scope of the invention.

Memory 110 may include instructions for other processes that may be executed by processor 105 in response to a command from customer terminal 120. For example, memory 110 may store instructions for comparing any two archives stored in database 115 by any two executions of process 300 and/or process 200.

Processes 200 and 300 may include a filename or keyword search feature, whereby an alert may be issued to customer terminal 120 if any customer-provided keywords or filenames are found in the website.

Processes 200 and 300 may be implemented to alert the customer of website activity by a competitor. In doing so, the customer may provide a target domain (at step 205), which is the home web page of a competitor. The customer may further provide scan frequency information (at step 210) to archive the target domain on a daily basis. Because processes 200 and 300 may reveal and archive any hidden links, files, and the like, the customer may uncover data pertaining to the competitor's ranking in search engine results.

It will be apparent to those skilled in the art that various modifications and variations can be made in the present invention without departing from the spirit or scope of the invention. Thus, it is intended that the present invention cover the modifications and variations of this invention provided they come within the scope of the appended claims and their equivalents.

What is claimed is:

1. A system for archiving a website, comprising:
a processor connected to the internet;
a customer terminal connected to the internet;
a database connected to the processor; and
a memory connected to the processor, wherein the memory is encoded with a program for obtaining a target domain from the customer terminal, obtaining a scan frequency information from the customer terminal, downloading a first web page data corresponding to the target domain at a first time corresponding to the scan frequency information, encrypting and storing the first web page data, downloading a second web page data corresponding to the target domain at a second time, computing a percentage change corresponding to the first web page data and the second web page data and reporting the percent change to the customer terminal.

2. A method for archiving a website, comprising:
obtaining a target domain from a customer terminal;
obtaining a scan frequency information from the customer terminal;
downloading a first web page data corresponding to the target domain at a first time corresponding to the scan frequency information;
encrypting and storing the first web page data;
downloading a second web page data corresponding to the target domain at a second time;
computing a percentage change corresponding to the first web page data and the second web page data; and
reporting the percent change to the customer terminal.

3. The method of claim 2, wherein encrypting and storing the first web page data comprises:
computing and storing a text data word count;
identifying and storing a plurality of links within the first web page data; and
storing an HTML source code corresponding to the first web page data.
